(19) United States
(12) Patent Application Publication
(10) Pub. No.: US 2021/0295825 A1
(43) Pub. Date: Sep. 23, 2021

(54) USER VOICE BASED DATA FILE COMMUNICATIONS

(71) Applicant: Hewlett-Packard Development Company, L.P., Spring, TX (US)

(72) Inventors: Yi-Fan Hsia, Taipei City (TW); Chia-Cheng Lin, Taipei City (TW); Hung Lung Chen, Taipei City (TW)

(73) Assignee: Hewlett-Packard Development Company, L.P., Spring, TX (US)

(21) Appl. No.: 17/261,585

(22) PCT Filed: Nov. 1, 2018
(86) PCT No.: PCT/US2018/058749

§ 371 Date: Jan. 20, 2021

(51) Int. Cl. G10L 15/08; G06K 9/00; G10L 15/25

(52) U.S. Cl. CPC G10L 15/08; G10L 15/25; G06K 9/00268

(57) ABSTRACT

According to examples, an apparatus may include a communication interface and a controller. The controller may determine whether a data file includes a user's captured voice and may, based on a determination that the data file includes the user's captured voice, communicate the data file through the communication interface.

### BACKGROUND

Telecommunications applications, such as teleconferencing and videoconferencing applications, may facilitate communications between multiple remotely located users to communicate with each other over an Internet Protocol network, over a land-based telephone network, and/or over a cellular network. Particularly, the telecommunications applications may cause audio to be captured locally for each of the users and communicated to the other users such that the users may hear the voices of the other users via these networks. Some telecommunications applications may also enable still and/or video images of the users to be captured locally and communicated to the other users such that the users may see the other users via these networks.

### BRIEF DESCRIPTION OF DRAWINGS

Features of the present disclosure are illustrated by way of example and not limited in the following figure(s), in which like numerals indicate like elements, in which:

FIG. 1 shows a block diagram of an example apparatus that may control communication of a data file based on whether the data file includes a user's captured voice;

FIG. 2 shows a block diagram of an example system that may include features of the example apparatus depicted in FIG. 1;

FIG. 3 shows a block diagram of an example apparatus that may control communication of captured audio based on whether the captured audio includes a user's voice;

FIG. 4 shows an example method for controlling the output of data files including captured audio; and

FIG. 5 shows a block diagram of an example non-transitory computer readable medium that may have stored thereon machine readable instructions that when executed by a processor, may cause the processor to control the communication of a data file corresponding to a captured sound based on whether the data file includes a user's voice.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote one of a particular element or multiple ones of the particular element. As used herein, the term “includes” means includes but not limited to, the term “including” means including but not limited to. The term “based on” may mean based in part on.

Microphones may generally capture any audio in the vicinities of the microphones and all of the captured audio may be communicated across to a network during teleconferencing and videoconferencing sessions. That is, all of the audio, including background noise, voices from persons other than those persons that are participants of the sessions, etc., may be captured and communicated. As a result, the other participants of the sessions in locations remote from the location at which the audio was captured may receive audio that was not intended to be communicated to the participants.

Disclosed herein are apparatuses, systems, and methods for controlling the output of captured audio over a network through a communications interface based on a user's voice. That is, the apparatuses and systems disclosed herein may determine whether captured audio includes a user's voice and may control the output of the captured audio based on the determination. For instance, a data file corresponding to the captured audio may be communicated based on a determination that the captured audio includes the user's voice. However, a data file corresponding to the captured audio may be discarded, e.g., may not be communicated based on a determination that the captured audio does not include the user's voice.

According to examples, the determination as to whether the captured audio includes the user's voice may be made in any of a number of manners. For instance, the determination may be made based on a determination as to whether an image captured concurrently with the capture of the audio includes an image of the user. In addition, or alternatively, the determination may be made based on a determination as to whether the user was looking into the camera and/or a screen when the audio was captured. In addition, or alternatively, the determination may be made based on whether a user's mouth in a plurality of images captured during a time frame at which the audio was captured is determined to have moved. In addition, or alternatively, the determination may be made based on whether the captured audio includes a recognized voice of the user.

Through implementation of the apparatuses, systems, and methods disclosed herein, output of audio during a teleconference and/or a videoconference session may selectively be controlled such that audio that does not include a user's voice may not be output. That is, for instance, only audio that includes the user's voice may be outputted to the teleconference and/or the videoconference session. As a result, audio that may not be intended for the participants to hear may not be transmitted to the teleconference and/or the videoconference session.

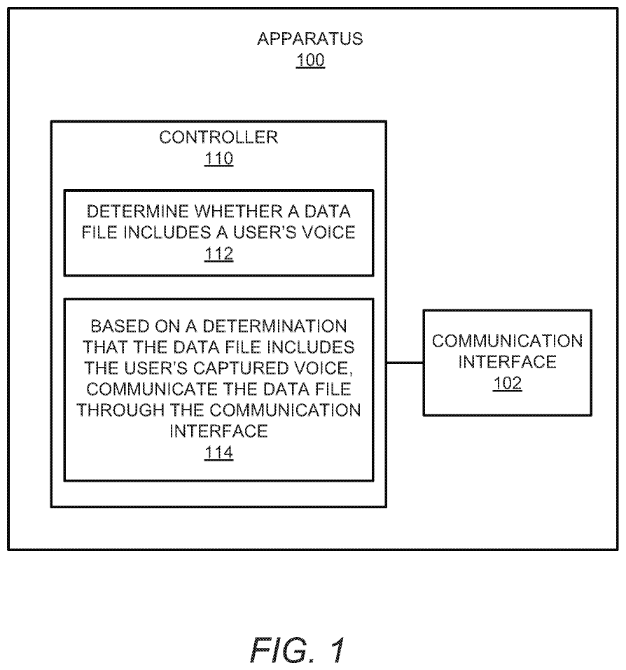

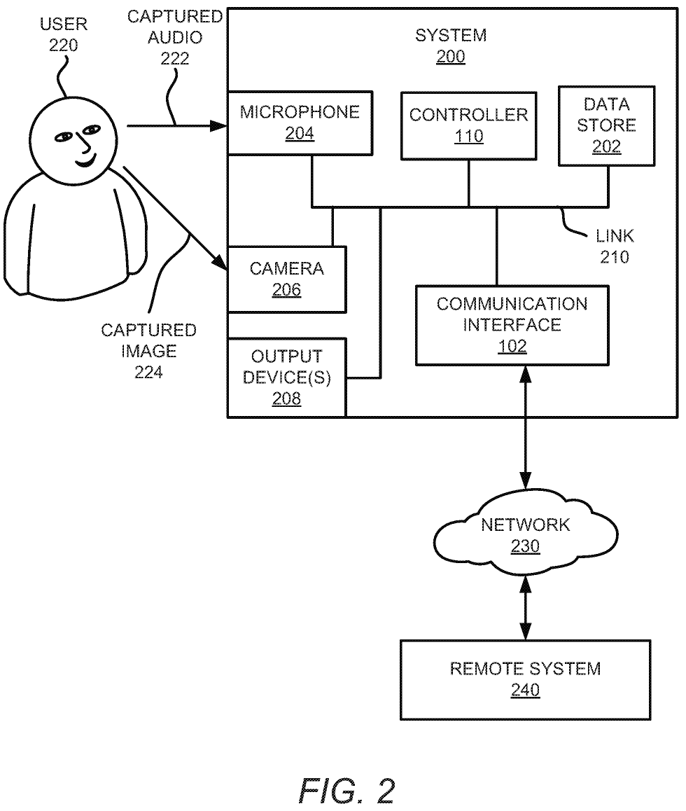

Reference is first made to FIGS. 1 and 2. FIG. 1 shows a block diagram of an example apparatus 100 that may control communication of a data file based on whether the data file includes a user's captured voice. FIG. 2 shows a block diagram of an example system 200 that may include features of the example apparatus 100 depicted in FIG. 1. It should be understood that the example apparatus 100 and/or the example system 200 depicted in FIGS. 1 and 2 may include additional components and that some of the components described herein may be removed and/or modified without departing from the scopes of the example apparatus 100 and/or the example system 200 disclosed herein.

The apparatus 100 may be a computing device or other electronic device that may facilitate communication by a user with other remotely located users. That is, the apparatus 100 may capture audio and may selectively communicate audio signals, e.g., data files including the audio signals, of the captured audio over a communication interface 102. As discussed herein, the apparatus 100, and more particularly, a controller 110 of the apparatus 100, may determine whether the audio signals include audio intended by the user to be communicated to another user, e.g., via execution of a videoconferencing application, and may communicate the audio signals based on a determination that the user intended for the audio to be communicated to the other user. However, based on a determination that the user may not have intended for the audio to be communicated, the controller 110 may not communicate the audio signals. The controller 110 may determine the user's intent with respect to whether the audio is to be communicated in various manners as discussed herein.

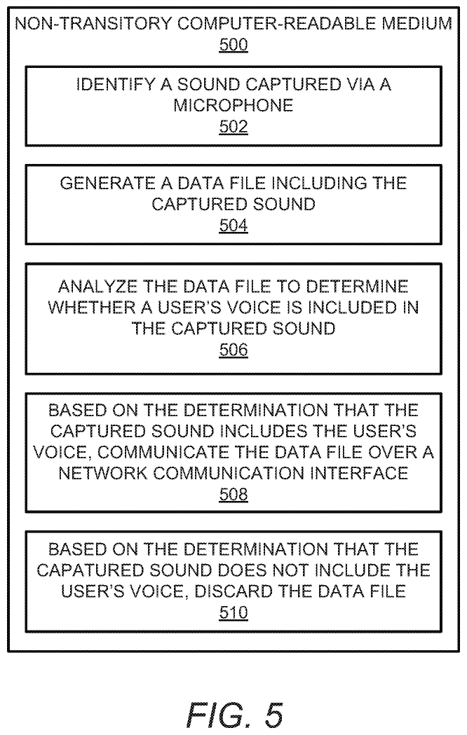

The communication interface 102 may include software and/or hardware components through which the apparatus 100 may communicate and/or receive data files. For instance, the communication interface 102 may include a network interface of the apparatus 100. The data files may include audio and/or video signals, e.g., packets of data corresponding to audio and/or video signals. The controller 110 may be an integrated circuit, such as an application-specific integrated circuit (ASIC). In these examples, instructions that the controller 110 may execute may be programmed into the integrated circuit. In other examples, the controller 110 may operate with firmware (i.e., machine-readable instructions) stored in a memory (e.g., the non-transitory computer readable medium shown in FIG. 5). In these examples, the controller 110 may be a microprocessor, a CPU, or the like, and the instructions may be firmware and/or software that the controller 110 may execute as discussed in detail herein.

As shown in FIG. 2, the system 200 may include the communication interface 102 and the controller 110 of the apparatus 100 depicted in FIG. 1. The system 200 may also include a data store 202, a microphone 204, a camera 206, an output device (or multiple output devices) 208. Electrical signals may be communicated between some or all of the components 102, 110, 202-208 of the system 200 via a link 210, which may be communication bus, a wire, and/or the like.

The controller 110 may execute or otherwise implement a telecommunications application to facilitate a teleconference or a videoconference meeting to which a user 220 may be a participant. In this regard, the microphone 204 may capture audio (or equivalently, sound) 222 during the meeting for communication across a network 230 to which the communication interface 102 may be connected. The microphone 204 may capture the user's 220 voice and/or other audio, including other people's voices, background noises, etc. The network 230 may be an IP network, a telephone network, and/or a cellular network. In addition, the captured audio 222 may be communicated across the network 230 to a remote system 240 such that the captured audio 222 may be outputted at the remote system 240. The captured audio 222 may be converted and/or stored in a data file and the communication interface 102 may communicate the data file over the network 230.

In operation, the microphone 204 may capture the audio 222 and may communicate the captured audio 222 to the data store 202 and/or the controller 110. In addition, the microphone 204 or another component may convert the captured audio 222 or may store the captured audio 222 in a data file. For instance, the captured audio 222 may be stored or encapsulated in IP packets. The controller 110 may determine (instructions 112) whether the captured audio 222 include a user's 220 voice. That is, the controller 110 may determine whether the data file including the captured audio 220 includes the user's 220 captured voice. The controller 110 may make this determination in any of multiple manners as discussed herein.

The controller 110, based on a determination that the data file includes the user's 220 captured voice, communicate (instructions 114) the data file through the communication interface 102. In addition, the communication interface 102 may output the data file (e.g., including the captured audio 222) over the network 230 to the remote system 240. However, based on a determination that the captured audio 222 does not include the user's 220 voice, the controller 110 may discard the data file, e.g., may not communicate the captured audio 222 to the communication interface 102. As a result, the captured audio 222 may not be outputted to the network 230 when the data file does not include the user's 220 captured voice, which may be an indication that the user 220 did not intend for the captured audio 222 to be communicated to another participant of the teleconference or videoconference.

As shown in FIG. 2, the camera 206 may capture an image 224 or multiple images 224, e.g., video, within the field of view of the camera 206 when the camera 206 is active, such as when the controller 110 is executing a videoconferencing application. In some examples, the controller 110 may control the camera 206 such that the captured images 224 are continuously recorded in the data store 202 during execution of the videoconferencing application. In other examples, the controller 110 may cause images 224 to be recorded concurrently with the captured audio 222. In any of these examples, the images 224 that were captured during a time period at which the audio 222 was captured may be linked with the captured audio 222. As such, the images 224 corresponding to the time frame during which the audio 222 was captured may be identified such as with common time stamps or the like.

The output device(s) 208 shown in the system 200 may include, for instance, a speaker, a display, and the like. The output device(s) 208 may output audio received, for instance, from the remote system 240. The output device(s) 208 may also output images and/or video received from the remote system 240.

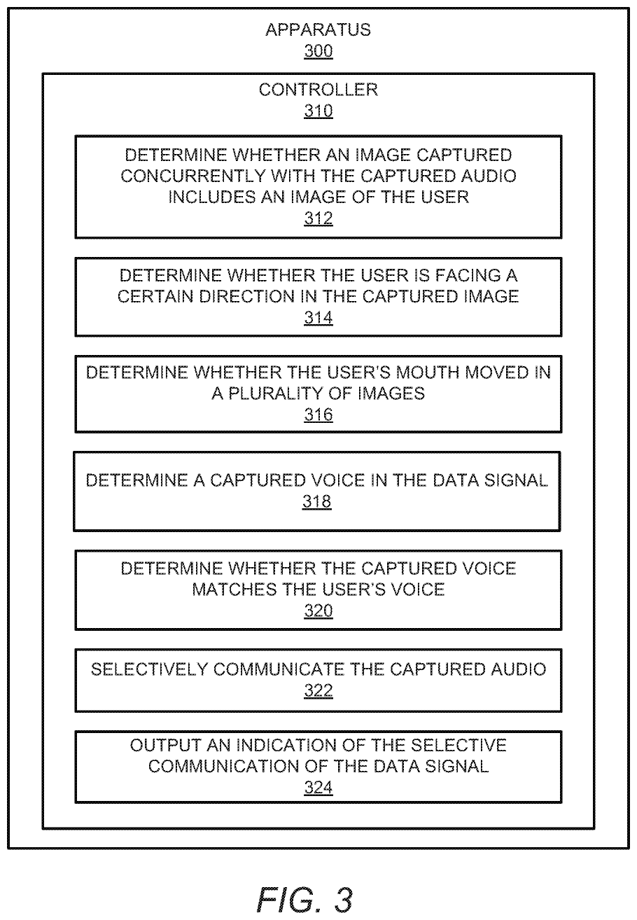

Reference is now made to FIGS. 1-3. FIG. 3 shows a block diagram of an example apparatus 300 that may control communication of captured audio 222 based on whether the captured audio 222 includes a user's 220 voice. It should be understood that the example apparatus 300 depicted in FIG. 3 may include additional components and that some of the components described herein may be removed and/or modified without departing from the scope of the example apparatus 300 disclosed herein.

The apparatus 300 may be similar to the apparatus 100 depicted in FIG. 1 and may thus include the communication interface 102 discussed herein with respect to FIG. 1. The apparatus 300 may also include a controller 310, which may be similar to the controller 110. The instructions 312-320 may be examples of the instruction 112 and the instruction 322 may be an example of the instruction 114. Particularly, the controller 310 may implement and/or execute any of the instructions 312-320 to determine whether a captured audio 222 includes a user's 220 voice as discussed above with respect to the instructions 112.

In some examples, the controller 310 may determine (instructions 312) whether an image 224 captured concurrently with the captured audio 222 included in the data file includes an image of the user 220. Particularly, for instance, the controller 310 may determine whether the image 224 captured concurrently with the captured audio 222 includes an image of the user's 220 face. The controller 310 may determine (instructions 320) that the data file that includes the captured audio 222 includes the user's 220 captured voice based on a determination that the captured image 224 includes the image of the user 220, e.g., the user's 220 face. However, the controller 310 may determine (instructions 320) that the data file that includes the captured audio 222 does not include the user's 220 captured voice based on a determination that the captured image 224 does not include the image of the user 220, e.g., the user's 220 face.

In some examples, the controller 310 may determine (instructions 312) that an image captured concurrently with the captured audio 222 included in the data file includes an image of the user 220. In addition, the controller 310 may determine (instructions 314) whether the user 220 is facing a certain direction in the captured image 224. That is, for instance, the controller 310 may determine whether the user 220 is facing the camera 206 and/or a display (output device 208) in the captured image 224. Based on a determination that the user 220 is facing the certain direction, the controller 310 may determine (instructions 320) that the data file includes the user's 220 captured voice. That is, the controller 310 may determine that the data file includes the user's 220 captured voice on the basis that the captured audio 222 likely includes the user's 220 voice. However, based on a determination that the user 220 is not facing the certain direction, the controller 110 may determine (instructions 320) that the data file does not include the user's 220 captured voice. That is, when the user 220 is not facing the camera 206 or the display 208 when the audio 222 is captured, the captured audio 222 likely did not come from the user 220.

In some examples, the controller 310 may determine (instructions 312) that a plurality of images captured concurrently with the captured audio 222 included in the data file includes images of the user 220. The controller 310 may also identify the user's mouth in the plurality of captured images 224 and may determine (instructions 316) whether the user's 220 mouth moved among the plurality of images 224. That is, the controller 310 may determine whether the user's 220 mouth moved during the time at which the audio 222 was captured from the captured images 224. Based on a determination that the user's 220 mouth moved among the plurality of images 224, the controller 310 may determine (instructions 320) that the data file includes the user's 220 captured voice. However, based on a determination that the user's 220 mouth did not move among the plurality of images 224, the controller 310 may determine (instructions 320) that the data file does not include the user's 220 captured voice. The controller 310 may utilize facial recognition technology to identify the user's 220 mouth and to determine whether user's mouth 220 moved among the images 224.

In some examples, the controller 310 may determine (instructions 318) a captured voice in the data file. The controller 310 may determine (instructions 320) whether the captured voice matches a recognized voice of the user 220. That is, for instance, the controller 310 may have executed a voice recognition application to identify the user's 220 voice, e.g., features of the user's 220 voice, and may have stored the recognized voice in the data store 202. In addition, the controller 310 may execute the voice recognition application to determine features of the captured voice in the data file and may compare the determined features of the captured voice with determined features of the user's 220 voice to determine whether the captured voice matches the recognized voice of the user 220. The controller 310 may further determine (instructions 322) that the data file includes the user's 220 captured voice based on the captured voice matching the recognized voice of the user 220. However, the controller 310 may determine (instructions 322) that the data file does not include the user's captured voice based on the captured voice not matching the recognized voice of the user.

In some examples, the controller 310 may output (instructions 324) an indication of the selective communication of the data file. For instance, the controller 310 may output an indication, e.g., display a notification, output an audible alert, or the like, that the data file has not been communicated based on the determination that the data file does not include the user's 220 captured voice.

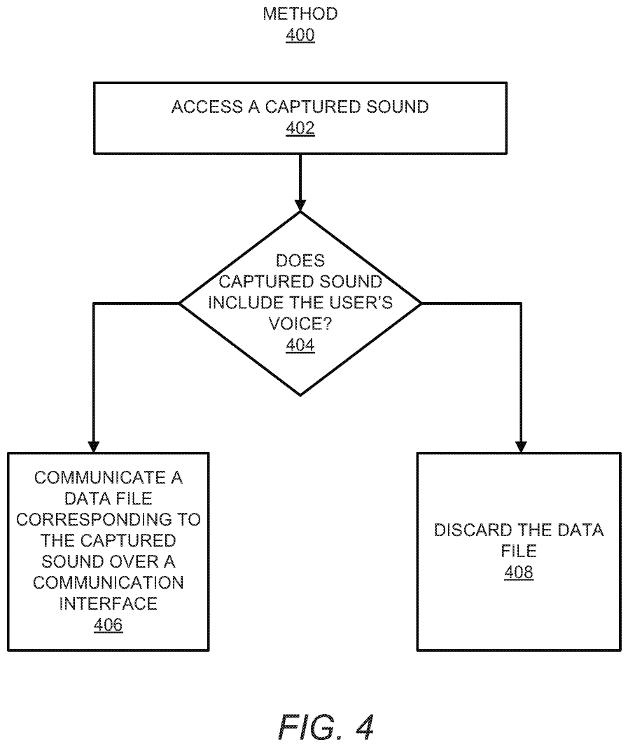

Various manners in which the apparatuses 100, 300 may be implemented are discussed in greater detail with respect to the method 400 depicted in FIG. 4. Particularly, FIG. 4 depicts an example method 400 for controlling the output of data files including captured audio 222. It should be apparent to those of ordinary skill in the art that the method 400 may represent a generalized illustration and that other operations may be added or existing operations may be removed, modified, or rearranged without departing from a scope of the method 400.

The description of the method 400 is made with reference to the apparatuses 100, 300 illustrated in FIGS. 1-3 for purposes of illustration. It should be understood that apparatuses having other configurations may be implemented to perform the method 400 without departing from a scope of the method 400.

At block 402, the controller 110, 310 may access a captured sound 222. The controller 110, 310 may access the captured sound 222 from the microphone 204 and/or from the data store 202. At block 404, the controller 110, 310 may analyze the captured sound 222, or a data file including the captured sound 222, to determine whether the captured sound 222 includes a user's 220 voice. Particularly, for instance, the controller 110, 310 may determine whether the captured sound 222 includes a particular user's 220 voice or whether the captured sound 222 does not include the particular user's 220 voice. That is, the controller 110, 310 may determine whether the captured sound 222 includes a particular user's 220 voice, any user's voice, background noise, etc. Various manners in which the controller 110, 310 may determine whether the captured sound 222 includes the user's 220 voice are described above.

At block 406, based on a determination that the captured sound 222 includes the user's 220 voice, the controller 110, 310 may communicate a data file corresponding to the captured sound 222 over a communication interface 102. However, based on a determination the captured sound 222 does not include the user's 220 voice, at block 408, the controller 110, 310 may discard the data file, for instance, by not communicating the data file over the communication interface 102.

Some or all of the operations set forth in the method 400 may be contained as utilities, programs, or subprograms, in any desired computer accessible medium. In addition, some or all of the operations set forth in the method 400 may be embodied by computer programs, which may exist in a variety of forms both active and inactive. For example, they may exist as machine readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Turning now to FIG. 5, there is shown a block diagram of an example non-transitory computer readable medium 500 that may have stored thereon machine readable instructions that when executed by a processor, which may be the controller 110, 310, may cause the processor to control the communication of a data file corresponding to a captured sound based on whether the data file includes a user's voice. It should be understood that the non-transitory computer readable medium 500 depicted in FIG. 5 may include additional instructions and that some of the instructions described herein may be removed and/or modified without departing from the scope of the non-transitory computer readable medium 500 disclosed herein.

The non-transitory computer readable medium 500 may have stored thereon machine readable instructions 502-508 that a processor may execute. The non-transitory computer readable medium 500 may be an electronic, magnetic, optical, or other physical storage device that contains or stores executable instructions. The -transitory computer readable medium 500 may be, for example, Random Access memory (RAM), an Electrically Erasable Programmable Read-Only Memory (EEPROM), a storage device, an optical disc, and the like. The term “non-transitory” does not encompass transitory propagating signals.

The processor may fetch, decode, and execute the instructions 502 to identify a sound 222 captured via a microphone 204. The processor may fetch, decode, and execute the instructions 504 to generate a data file including the captured sound. The processor may fetch, decode, and execute the instructions 506 to analyze the data file to determine whether a user's voice is included in the captured sound 222. The processor may make this determination in any of the manners discussed above. The processor may fetch, decode, and execute the instructions 508 to, based on a determination that the captured sound 222 includes the user's 220 voice, communicate the data file corresponding to the captured sound 222 over a network communication interface 102. The processor may fetch, decode, and execute the instructions 510 to, based on a determination that the captured sound 222 does not include the user's 220 voice, discard the data file, e.g., may not communicate the data file over the network communication interface 102.

Although described specifically throughout the entirety of the instant disclosure, representative examples of the present disclosure have utility over a wide range of applications, and the above discussion is not intended and should not be construed to be limiting but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a communication interface; and
a controller to:
determine whether a data file includes a user's captured voice; and
based on a determination that the data file includes the user's captured voice, communicate the data file through the communication interface.

2. The apparatus of claim 1, wherein the controller is further to:
determine whether an image captured concurrently with captured audio included in the data file includes an image of the user; and
determine that the data file includes the user's captured voice based on a determination that the captured image includes the image of the user.

3. The apparatus of claim 1, wherein the controller is further to:
determine that an image captured concurrently with the captured audio included in the data file includes an image of the user;
determine whether the user is facing a certain direction in the captured image;
based on a determination that the user is facing the certain direction, determine that the data file includes the user's captured voice; and
based on a determination that the user is not facing the certain direction, determine that the data file does not include the user's captured voice.

4. The apparatus of claim 1, wherein the controller is further to:
determine that a plurality of images captured concurrently with captured audio included in the data file includes images of the user;
identify the user's mouth in the plurality of captured images;
determine whether the user's mouth moved among the plurality of images;
based on a determination that the user's mouth moved among the plurality of images, determine that the data file includes the user's captured voice; and
based on a determination that the user's mouth did not move among the plurality of images, determine that the data file does not include the user's captured voice.

5. The apparatus of claim 1, wherein the controller is further to:
determine a captured voice in the data file;
determine whether the captured voice matches a recognized voice of the user;
determine that the data file includes the user's captured voice based on the captured voice matching the recognized voice of the user; and
determine that the data file does not include the user's captured voice based on the captured voice not matching the recognized voice of the user.

6. The apparatus of claim 1, wherein the controller is further to:
based on a determination that the data file does not include the user's captured voice, discard the data file; and
output an indication that the data file has not been communicated.

7. A system comprising:
a microphone; and
a controller to:
determine whether a sound captured by the microphone includes a user's voice;
based on a determination that the captured sound includes the user's voice, output a data file including the captured sound to a communication interface; and
based on a determination that the captured sound does not include the user's voice, discard the data file.

8. The system of claim 7, further comprising:
a camera to capture images; and
wherein the controller is further to:
determine whether the camera captured an image of the user at a time when the microphone captured the sound;
determine that the captured sound includes the user's voice based on a determination that the image of the user was captured at the time when the microphone captured the sound; and
determine that the captured sound does not include the user's voice based on a determination that the image of the user was not captured at the time when the microphone captured the sound.

9. The system of claim 7, further comprising:
a camera; and
wherein the controller is further to:
determine that the camera captured an image of the user at a time when the microphone captured the sound;
determine whether the user is facing the camera in the captured image;
based on a determination that the user is facing the camera in the captured image, determine that the captured sound includes the user's voice; and
based on a determination that the user is not facing the camera in the captured image, determine that the captured sound does not include the user's voice.

10. The system of claim 7, further comprising:
a camera;
wherein the controller is further to:
determine that the camera captured a plurality of images of the user during a time period at which the microphone captured the sound;
identify the user's mouth in the plurality of captured images;
determine whether the user's mouth moved during the time period at which the microphone captured the sound from the plurality of captured images;
determine that the captured sound includes the user's voice based on a determination that the user's mouth moved during the time period at which the microphone captured the sound; and
determine that the captured sound does not include the user's voice based on a determination that the user's mouth did not move during the time period at which the microphone captured the sound.

11. The system of claim 7, wherein the controller is further to:
determine a voice in the captured sound;
determine whether the determined voice matches a recognized voice of the user;
determine that the captured sound includes the user's voice based on the determined voice matching the recognized voice of the user; and
determine that the captured sound does not include the user's voice based on the determined voice not matching the recognized voice of the user.

12. A non-transitory computer readable medium on which is stored machine readable instructions that when executed by a processor, cause the processor to:
identify a sound captured via a microphone;
generate a data file including the captured sound;
analyze the data file to determine whether a user's voice is included in the captured sound;
based on a determination that the captured sound includes the user's voice, communicate the data file corresponding to the captured sound over a network communication interface; and
based on a determination that the captured sound does not include the user's voice, discard the data file.

13. The non-transitory computer readable medium of claim 12, wherein the instructions are further to cause the processor to:
determine whether an image captured concurrently with the captured sound includes an image of the user;
determine that the captured sound includes the user's voice based on a determination that the captured image includes an image of the user; and
determine that the captured sound does not include the user's voice based on a determination that the captured image does not include an image of the user.

14. The non-transitory computer readable medium of claim 12, wherein the instructions are further to cause the processor to:
access a plurality of images of the user that were captured during a time period at which the sound was captured;
identify the user's mouth in the plurality of captured images;
determine whether the user's mouth moved during the time period at which the sound was captured from the plurality of captured images;
determine that the captured sound includes the user's voice based on a determination that the user's mouth moved during the time period at which the sound was captured; and
determine that the captured sound does not include the user's voice based on a determination that the user's mouth did not move during the time period at which the sound was captured.

15. The non-transitory computer readable medium of claim 12, wherein the instructions are further to cause the processor to:
determine a voice in the captured sound;
determine whether the determined voice matches a recognized voice of the user;
determine that the captured sound includes the user's voice based on the determined voice matching the recognized voice of the user; and
determine that the captured sound does not include the user's voice based on the determined voice not matching the recognized voice of the user.
